(19) United States
(12) Patent Application Publication
(10) Pub. No.: US 2024/0193877 A1
(43) Pub. Date: Jun. 13, 2024

(54) VIRTUAL PRODUCTION

(71) Applicant: Mannequin Technologies, Inc., Los Angeles, CA (US)

(72) Inventors: Aleksei Podkin, Playa Vista, CA (US); Roman Ushakov, London (GB); Yurii Monastyrshyn, Playa Vista, CA (US); Kiram Alharba, Dubai (AE); Maxim Ostroukhov, Moscow (RU); Arthur Mulikhov, Kazan (RU)

(21) Appl. No.: 18/379,076

(22) Filed: Oct. 11, 2023

Related U.S. Application Data
(60) Provisional application No. 63/431,971, filed on Dec. 12, 2022.

(51) Int. Cl. G06T 19/00; G06T 1/20

(52) U.S. Cl. CPC G06T 19/006; G06T 1/20; G06T 2219/2024

(57) ABSTRACT

Various embodiments described herein provide a virtual production system that comprises a set of skin machine-learning models, a set of upper-body machine-learning models, a memory storing instructions, and one or more hardware processors to perform several operations based on stored instructions. Operations can comprise receiving a first image depicting a three-dimensional figure in a posing position and dressed in select apparel. Operations can comprise using the set of skin machine-learning models to generate a second image, where the set of skin machine-learning models up-sample the skin of the three-dimensional figure to generate photorealistic skin. Also, operations can comprise using the set of upper-body machine-learning models to generate a third two-dimensional image, where the set of upper-body machine-learning models up-sample an upper portion of the three-dimensional figure to generate a photorealistic upper portion.

### CROSS-REFERENCE TO RELATED APPLICATION

This application claims priority to and the benefit of U.S. Provisional Patent Application No. 63/431,971, filed on Dec. 12, 2022, the contents of which are incorporated herein by reference in its entirety.

### TECHNICAL FIELD

The present disclosure relates generally to a method and system for virtual production and, more particularly, but not by way of limitation, to systems, methods, techniques, instruction sequences, and devices that generate photorealistic images simulating fashion photoshoots of models wearing apparel items.

### BACKGROUND

With the use of technology, companies are now able to design new apparel items and display these items in three-dimensional formats using special software. Additionally, with the wide use of the Internet, it is beneficial to display these new apparel items to consumers online using virtual production. Virtual production can refer to a method that uses computer-generated imagery (CGI), augmented reality, or other technologies to create realistic environments and effects in virtual settings. The use of virtual production can obviate the need to use real-life humans to model apparel.

### BRIEF DESCRIPTION OF THE DRAWINGS

In the drawings, which are not necessarily drawn to scale, like numerals can describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings.

FIG. 1 is a block diagram showing an example data system that comprises a virtual production model, according to various embodiments of the present disclosure.

FIG. 2 is a block diagram illustrating an example virtual production model, according to various embodiments of the present disclosure.

FIG. 3 is a block diagram illustrating data flow within an example virtual production model during operation, according to various embodiments of the present disclosure.

FIG. 4 provides a block diagram illustrating data flow within an example virtual production model during operation, according to various embodiments of the present disclosure.

FIG. 5 is a flowchart illustrating an example method for virtual production, according to various embodiments of the present disclosure.

FIG. 6 provides a flowchart illustrating an example method for virtual production, according to various embodiments of the present disclosure.

FIG. 7 is a block diagram illustrating a representative software architecture, which can be used in conjunction with various hardware architectures herein described, according to various embodiments of the present disclosure.

FIG. 8 provides a block diagram illustrating components of a machine able to read instructions from a machine storage medium and perform any one or more of the methodologies discussed herein according to various embodiments of the present disclosure.

### DETAILED DESCRIPTION

Planning photoshoots can be time-consuming and expensive for both small and large apparel brands. Planning includes tasks such as: developing concepts, defining goals, picking locations, setting up equipment, organizing crew and talent (models), and outlining the shooting schedule, to name a few. Branding photographers also charge extensive amounts of money per photo shoot, which can become very expensive over time. For apparel brands, photography can be the most important part of branding as this is how the brand reaches its audience and displays its product to consumers With new technology, however, companies are now able to design new apparel items in three-dimensional formats using special software. After completing the design, the newly created apparel item can be exported as a three-dimensional model file. With the wide use of the Internet, it is ideal to display these three-dimensional apparel items to consumers online using virtual production.

Various embodiments described herein address this concern and other deficiencies of conventional art. For example, various embodiments described herein can use virtual production as a method that uses computer-generated imagery (CGI), augmented reality, and other technologies to create realistic environments and effects in virtual settings. With this technology, the use of real-life humans to model apparel is no longer a necessity. Virtual production assists in the generation of photorealistic images that simulate fashion photoshoots of models wearing apparel items. Virtual production, thus, creates the illusion of a real-life person modeling real apparel. These realistic and human-like images of mannequins can be displayed in front of virtual but realistic backgrounds. Using these human-like mannequins can save companies time and money that otherwise would be spent on creating original content, such as organizing photoshoots with real-life humans. In various embodiments, with the use of virtual production, companies have the ability to upload images of apparel items and have a virtual background and a human-like mannequin wearing the uploaded apparel designed and created for them. In some examples, select apparel items can be three-dimensional. In some examples, the select apparel item can comprise writing, logos, and/or drawings.

More particularly, some embodiments described herein support or provide for an input being that of a set of three-dimensional model files for apparel items. These apparel items can be designed and generated with special software. Various embodiments herein describe a method and system using several machine-learning models, including for example skin machine-learning models, upper body machine-learning models, fabric simulation machine-learning models, and smooth blending models. The machine-learning models can work on three-dimensional human models, which were created in other three-dimensional software tools but were downloaded and then uploaded as an input into the system.

In some embodiments, the process includes setting up a three-dimensional model of a human, such as human body type and proportions, skin color, head, hair, and pose. Other embodiments allow an image of an existing model to be uploaded. Some embodiments select a template environment or provide the option to upload a preferred environment. Some embodiments also select a predefined camera angle. Once a model and environment are created or selected, the three-dimensional apparel items that were previously created, downloaded, and uploaded into the system can be used to dress the three-dimensional model created. This dressing process can include using three-dimensional software and performing manual work to address errors. Two-dimensional images are then rendered, for example, by use of current techniques and tools. Two-dimensional rendering generally uses a program like Photoshop to add color, texture, and shadows to a flat drawing.

Further embodiments apply one or more skin machine-learning models that take images of the skin (e.g., a two-dimensional render of a three-dimensional skin texture) as the input and predict a two-dimensional image as the output. The output comprises small changes over the input but provides a more photorealistic look. Some embodiments apply the upper body machine-learning models to the two-dimensional rendered images to make parts of the upper body, including but not limited to hands, face, hair, etc., look photorealistic.

In embodiments, one or more of the fabric simulation machine-learning models are for cloth simulation and are configured to up-sample the apparel item to generate a photorealistic apparel item. One or more of the fabric simulation machine-learning models are trained separately, specifically for cloth, and thus have different weights after training. During operation, one or more of the fabric simulation machine-learning models take images of the cloth (e.g., a two-dimensional render of a three-dimensional cloth texture) as the input and predict a two-dimensional image as the output where the output has small changes over the input but looks more photorealistic. The smooth blending models can be used as a blender-based tool to be a constructor for choosing options or moving sliders, accessible through a graphical interface or Python API, for example. The smooth blending models are configured to blend one or more undistorted regions to provide a more photorealistic image.

As used herein, a virtual mannequin can comprise a realistic and human-like mannequin that can be displayed in front of virtual backgrounds and that can be wearing apparel items (e.g., newly designed apparel items from different brands). The virtual mannequin can be used to create the illusion of a real person or cartoon character. Using virtual mannequins can save companies time and money when looking to display apparel items to the public. Taking advantage of virtual production can help companies save time that would otherwise be spent on creating original content, such as organizing photoshoots or creating commercials and advertisement campaigns. With the use of virtual production as described herein, companies can upload one or more images of apparel items and a virtual background, and a virtual mannequin wearing the uploaded apparel items is designed and created.

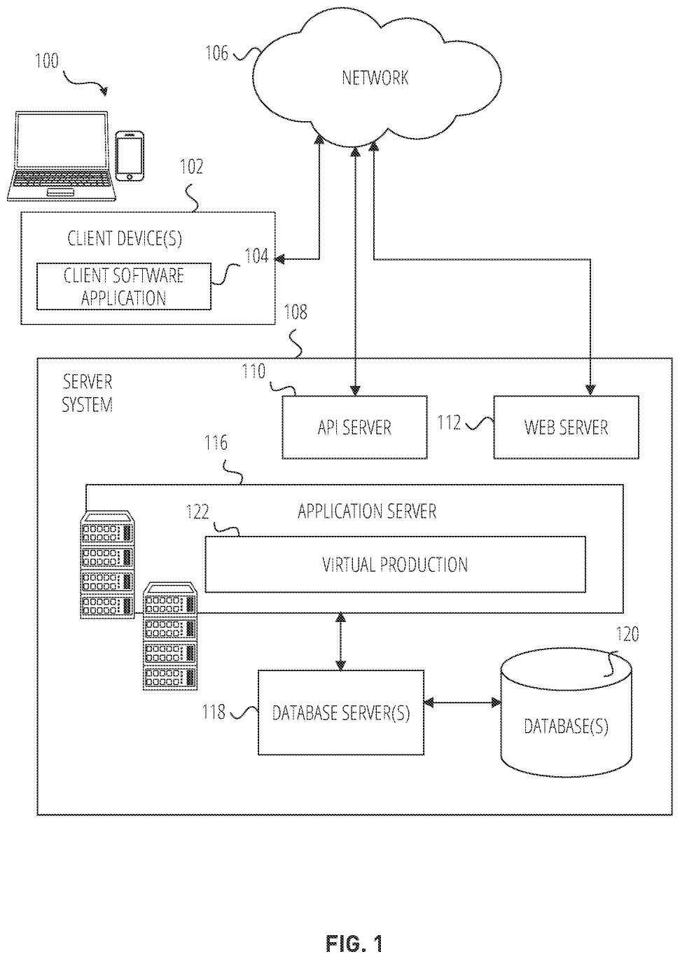

FIG. 1 is a block diagram showing an example data system that comprises virtual production, according to various embodiments of the present disclosure By including virtual production 122, the data system 100 can facilitate the generation of photorealistic images as described herein, which in turn can simulate fashion photoshoots of models wearing apparel items. In some examples, the apparel items can be three-dimensional. In some examples, the select apparel items can comprise writing, logos, and/or drawings.

In particular, a user at the client device 102 can access virtual production 122 (e.g., via a graphical user interface presented on a software application on the client device 102) and use virtual production 122 to simulate fashion photoshoots of models selected by the user. According to some embodiments, virtual production 122 first receives an image of a three-dimensional figure in a posing position and dressed in a select apparel item. A second image is generated using a set of skin machine-learning models. The set of skin machine-learning models can be configured to up-sample the skin of the three-dimensional figure to generate photorealistic skin in the second image. A third image can be generated using a set of upper-body machine-learning models. The set of upper-body machine-learning models configured to up-sample an upper portion of the three-dimensional figure to generate a photorealistic upper portion of the third image. Each model can be configured to transform certain parts of the body, including but not limited to hands, legs, face, hair, etc., to make the three-dimensional figure look photorealistic.

As shown, the data system 100 includes one or more client devices 102, a server system 108, and a network 106 (e.g., including the Internet, wide-area-network (WAN), local-area-network (LAN), wireless network, etc.) that communicatively couples them together. Each client device 102 can host a number of applications, including a client software application 104. The client software application 104 can communicate data with the server system 108 via a network 106. Accordingly, the client software application 104 can communicate and exchange data with the server system 108 via the network 106.

The server system 108 provides server-side functionality via the network 106 to the client software application 104. While certain functions of the data system 100 are described herein as being performed by virtual production 122 on the server system 108, it will be appreciated that the location of certain functionality within the server system 108 is a design choice. For example, it can be technically preferable to initially deploy certain technology and functionality within the server system 108, but to later migrate this technology and functionality to the client software application 104 where the client device 102 provides several models designed to transform certain parts of the body of a figure within a two-dimensional image to make the figure look and appear photorealistic. The models can include a set of skin machine-learning models, a set of upper-body machine-learning models, a set of fabric simulation machine-learning models, and a set of smooth blending models.

The server system 108 supports various services and operations that are provided to the client software application 104 by virtual production 122. Such operations include transmitting data from virtual production 122 to the client software application 104, receiving data from the client software application 104 to virtual production 122, and virtual production 122 processing data generated by the client software application 104. This data can comprise, for example, requests and responses relating to the training and use of the models, including one or more of the skin machine-learning models, upper-body machine-learning models, fabric simulation machine-learning models, and smooth blending models. Data exchanges within the data system 100 can be invoked and controlled through operations of software component environments available via one or more endpoints, or functions available via one or more user interfaces of the client software application 104, which can include web-based user interfaces provided by the server system 108 for presentation at the client device 102.

With respect to the server system 108, each of an Application Program Interface (API) server 110 and a web server 112 is coupled to an application server 116, which hosts the virtual production 122. The application server 116 is communicatively coupled to a database server 118, which facilitates access to a database 120 that stores data associated with the application server 116, including data that can be generated or used by virtual production 122.

The API Server 110 receives and transmits data (e.g., API calls 728, commands, requests, responses, and authentication data) between the client device 102 and the application server 116. Specifically, the API Server 110 provides a set of interfaces (e.g., routines and protocols) that can be called or queried by the client software application 104 in order to invoke functionality of the application server 116. The API Server 110 exposes various functions supported by the application server 116 including, without limitation: user registration; login functionality; data object operations (e.g., generating, storing, retrieving, encrypting, decrypting, transferring, access rights, licensing, etc.); and user communications.

Through one or more web-based interfaces (e.g., web-based user interfaces), the web server 112 can support various functionality of virtual production 122 of the application server 116 including, without limitation: requests and responses relating to the training and use of the models, including one or more of the skin machine-learning models, upper-body machine-learning models, fabric simulation machine-learning models, and smooth blending models. The application server 116 hosts a number of applications and subsystems, including virtual production 122, which supports various functions and services with respect to various embodiments described herein.

The application server 116 is communicatively coupled to a database server 118, which facilitates access to database(s) 120 in which can be stored data associated with virtual production 122. Data associated with virtual production 122 can include, without limitation, requests and responses relating to the training and use of models, including skin machine-learning models, upper-body machine-learning models, fabric simulation machine-learning models, and smooth blending models. The models are configured to up-sample certain portions of a three-dimensional figure to generate a photorealistic view of the figure. These models improve for example, skin and fabric to provide a more realistic view of the figure.

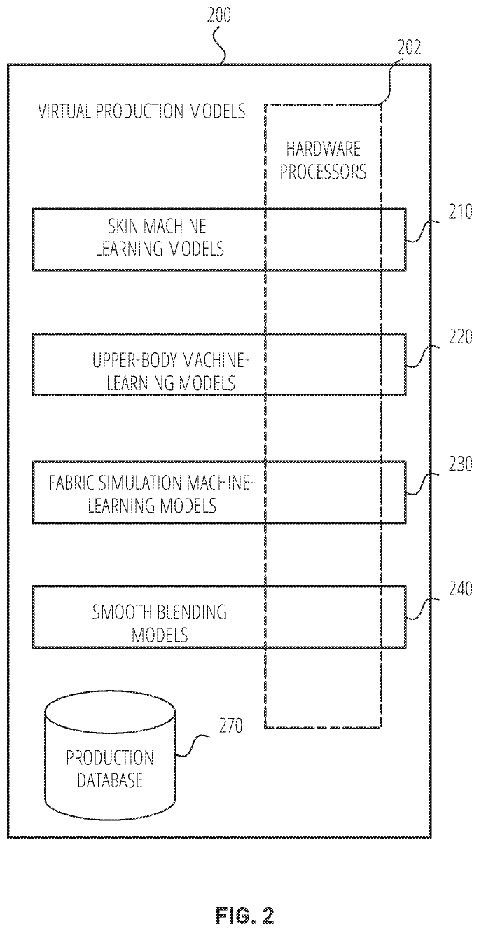

FIG. 2 is a block diagram illustrating an example virtual production model 200, according to various embodiments of the present disclosure. For some embodiments, virtual production models 200 represent examples of virtual production 122 described with respect to FIG. 1. As shown, the virtual production models 200 comprise skin machine-learning models 210, upper-body machine-learning models 220, fabric simulation machine-learning models 230, and smooth blending models 240.

According to various embodiments, one or more of the skin machine-learning models 210, upper-body machine-learning models 220, fabric simulation machine-learning models 230, and smooth blending models 240 are implemented by one or more hardware processors 202. Data generated by one or more of the skin machine-learning models 210, upper-body machine-learning models 220, fabric simulation machine-learning models 230, and smooth blending models 240 can be stored on a production database (or datastore) 270 of the virtual production models 200. Each of the machine-learning models 210, 220, 230, and 240 can work on three-dimensional human models, which were created by other three-dimensional software tools.

One or more of the skin machine-learning models 210 can be configured to generate a second two-dimensional image based on a first input that comprises a first two-dimensional image. The first input can comprise the set of skin machine-learning models 210 being configured to up-sample the skin of a rendered three-dimensional figure in the first two-dimensional image to generate photorealistic skin in the second two-dimensional image.

One or more of the skin machine-learning models 210 can take images of skin (e.g., two-dimensional rendering of a three-dimensional skin texture) as the input and predict a two-dimensional image as the output. The output can comprise small changes over the input but provides a more photorealistic look. For example, a graphical user interface can be displayed at a client device (e.g., 102), where the graphical user interface can enable a user at the client device to upload an image and using one or more of the skin machine-learning models 210 the skin within the image is made more realistic.

For some embodiments, one or more of the skin machine-learning models 210 can comprise a machine-learning model that is trained to automatically determine (e.g., identify) parts of a body within an image, including but not limited to hands, legs, face, hair, etc. provided by at least one computer vision analysis (e.g., video, visual effects, colors, etc.). For instance, one or more of the skin machine-learning models 210 can determine if skin is showing on a select part of the body where: the computer vision analysis can determine skin from an arm is present; skin from a leg is showing; and/or skin from other parts of the body is visible.

For some embodiments, as input images, parts or patches of the image of the whole human are used. During the inference of one or more of the skin machine-learning models 210 input images can be split into overlapping patches. Each patch can be upscaled separately and smoothly blend together. In some embodiments, patches overlap for better consistency after blending, thus providing better results. Accordingly, images can eventually be used to train (e.g., initially train or further train) one or more of the skin machine-learning models 210.

In some embodiments, one or more of the skin machine-learning models 210 can comprise a skin image distortion process. The skin image distortion process can segment a portion of skin of the rendered three-dimensional figure of the first two-dimensional image. The distortion process can also select one or more regions within the segmented portion and selects a size of a blur kernel, for example, between 0 and 253 for each of the one or more regions. The one or more regions can represent a different part of a body of the rendered three-dimensional figure of the first two-dimensional image. The distortion process can also apply a partial convolution layer with a Gaussian kernel to each of the one or more regions with a corresponding size of the blur kernel.

One or more of the upper-body machine-learning models 220 can be configured to generate a third two-dimensional image based on a second input that comprises the second two-dimensional image. The second input can also comprise the set of upper-body machine-learning models 220 being configured to up-sample an upper portion of the rendered three-dimensional figure in the second two-dimensional image to generate a photorealistic upper portion in the third two-dimensional image. In some examples, one or more of the upper-body machine-learning models 220 can focus on portions of the upper body. Some examples include human upper body parts above the waist including the hands, arms, forearms, shoulders, chest, back, stomach, neck, bead, etc. In some examples, a graphical user interface can be displayed at a client device (e.g., 102), where the graphical user interface can enable a user at the client device to upload an image and using one or more of the upper-body machine-learning models 220 the upper portions of the figure's body within the image are made more realistic.

One or more of the fabric simulation machine-learning models 230 can be configured to generate a fourth two-dimensional image based on a third input that comprises the third two-dimensional image. The set of fabric simulation machine-learning models 230 can be configured to up-sample the apparel item to generate a photorealistic apparel item in the fourth two-dimensional image. In some embodiments, the set of fabric simulation machine-learning models 230 can comprise a fabric image distortion process. The fabric image distortion process can comprise segmenting a portion of the apparel item in the third two-dimensional image. The distortion process can also include selecting one or more regions within the segmented portion and selecting a size of a blur kernel, for example, between 0 and 253 of the one or more regions. The one or more regions can represent a different fabric texture. The distortion process can also include applying a partial convolution layer with a Gaussian kernel to each of the one or more regions with a corresponding size of the blur kernel.

One or more of the fabric simulation machine-learning models 230 can be designed to make the apparel items or fabric appear and look photorealistic, where one or more of the fabric simulation machine-learning models 230 are trained separately, specifically for cloth and fabric and thus have different weights after training. During operation one or more of the fabric simulation machine-learning models 230 can take images of the cloth or fabric (e.g., two-dimensional render of a three-dimensional cloth texture) as the input and predict a two-dimensional image as the output. The output can comprise small changes over the input but looks and appears more photorealistic. One or more of the fabric simulation machine-learning models 230 can have a similar architecture to that of one or more of the skin machine-learning models 210.

For some embodiments, one or more of the fabric simulation machine-learning models 230 can be designed to smoothen the fabric to appear more photorealistic. For some embodiments, one or more of the fabric simulation machine-learning models 230 are machine-learning models trained to automatically determine (e.g., identify) different fabrics and differentiate the fabric from other parts of the body, including skin, for example. In some examples, the fabric or select apparel items can be three-dimensional. In some examples, the fabric or select apparel item can comprise writing, logos, and/or drawings. In examples, a graphical user interface can be displayed at a client device (e.g., 102), where the graphical user interface can enable a user at the client device to upload an image and using one or more of the fabric simulation machine-learning models 230 the fabric or apparel within the image is made more realistic.

The smooth blending models 240 can be configured to generate a fifth two-dimensional image based on a fourth input that comprises the fourth two-dimensional image. The input can also include the set of smooth blending models 240 being configured to blend one or more undistorted regions of the fourth two-dimensional image with one or more distorted regions of the third two-dimensional image. The one or more distorted regions of the third two-dimensional image can be generated by at least one of the set of skin machine-learning models 210 or the set of upper-body machine-learning models 220. The smooth blending models 240 in some examples can be used after use of one or more of the skin machine-learning models 210, upper-body machine-learning models 220, and/or fabric simulation machine-learning models 230 to provide a smooth appearance of the overall image. In an example, a graphical user interface can be displayed at a client device (e.g., 102), where the graphical user interface can enable a user at the client device to upload an image and using the smooth blending models 240 the skin, fabric, and/or upper body within the image, and/or the entire figure and/or image is made more realistic.

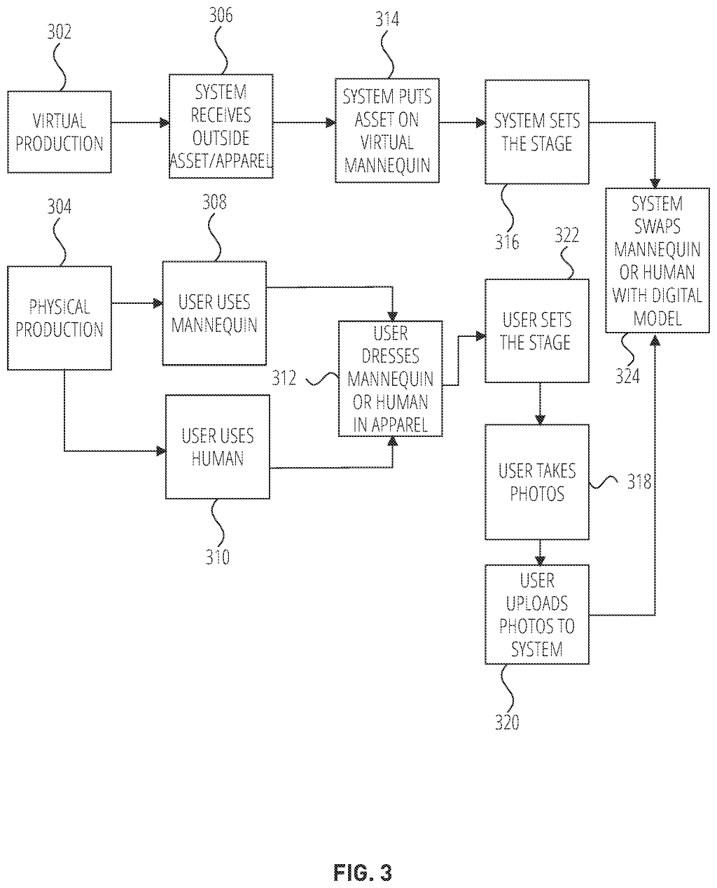

FIG. 3 is a block diagram illustrating data flow within an example virtual production 122 model during operation, according to various embodiments of the present disclosure. In some embodiments, during operation, a user can use virtual production 302 or physical production 304 after uploading an image. In general, with physical production 304, a user can use his or her own mannequin or model dressed in the actual and physical apparel items, set the stage, take photos, and upload the images or photos where the virtual production 122 model is applied to the images. Once the virtual production 122 model is applied to the images, the images of the human or mannequin are made more photorealistic.

The user also has the option to use virtual production 122 which in some examples allows the user to upload previously downloaded images of the apparel items only. For some embodiments, the virtual production 122 model allows the user to create his or her own mannequin or model dressed in the apparel items uploaded and set the stage. In embodiments, the final images are of mannequin models which, after applying the virtual production 122 model, now appear more photorealistic. In other examples, the user can use the virtual production 122 machine-learning models on three-dimensional human models which were created in other three-dimensional software tools but were downloaded and uploaded as an input into the system.

In FIG. 3, during operation 302, the user can use the virtual production model from beginning to end. Using the virtual production model, at operation 306, the system receives an outside asset/apparel. The outside asset or apparel items could have been designed and generated in special software outside of the virtual production model and are now being uploaded as the input to the system. The outside apparel or apparel items can be three-dimensional. Upon receiving the outside asset or apparel, at operation 314, the system places (e.g., dresses) the outside asset/apparel on a virtual mannequin. For some embodiments, a virtual mannequin is designed using virtual production 122. Virtual mannequins can also be designed for the user using pre-developed features.

Designing a human modeled mannequin can comprise steps such as setting up the body type (male or female), body proportions, and skin and hair color. This can also include selecting a head template or designing a new one Users can use a developed set of controls, which control, for example, eyes, nose, lips size, face shape, etc., or design new ones. In examples, the user can select from predeveloped models.

During operation 316, the system sets the stage for the virtual mannequin. Setting the stage allows the user to either select one of the template environment maps or upload a new one. The system also has the option to complete this step and can set the stage for the user. In examples, the template environment maps can be defined by High Dynamic Range Image (HDRI). This includes a multi-exposure high dynamic range (HDR) capture which is widely used to capture 360 real environments which are later used in three-dimensional rendering to simulate background and light conditions as seen in real scenes. Setting the stage can comprise selecting a predefined camera angle, for example close up, portrait, eye level, etc. in terms of distance to the camera and frontal, back, side etc. in terms of model's angle to the camera. This allows the user to get the desired shot.

In some examples, the user can select a predefined pose for the human model. For each pose (e.g., that a real-life fashion model can take during a photoshoot) there can be an animation for the human model to move from a default T pose to a desired pose. This allows physical corrections to the simulated collisions between the apparel items and the body. Once the human-like mannequin is designed or selected to the user's liking, the user can dress the mannequin in the outside apparel items received as the input. In some examples, the select apparel items can be three-dimensional. In some examples, the select apparel items can comprise writing, logos, and/or drawings. In examples, the image is a two-dimensional rendering of a three-dimensional image or model. The rendered three-dimensional figure can be that of a human figure

During operation 324, the system swaps mannequin or human with digital model 324. This operation applies the different virtual production models 200 described in FIG. 2. In some examples, the process of swapping the mannequin or human with the digital model can comprise using one or more of the skin machine-learning models 210, upper-body machine-learning models 220, fabric simulation machine-learning models 230, and/or smooth blending models 240. In some examples, one or more of the skin machine-learning models 210 can take images of the skin (e.g., two-dimensional render of a three-dimensional skin texture) as the input and predict a two-dimensional image as the output. The output can comprise small changes over the input but provides a more photorealistic look.

In some examples, one or more of the upper-body machine-learning models 220 make parts of the upper body, including but not limited to hands, legs, face, hair, etc. look photorealistic. The fabric simulation machine-learning models 230 are for cloth simulation and can be configured to up-sample the apparel item to generate a photorealistic apparel item. During operation, the fabric simulation machine-learning models 230 take images of the cloth (e.g., two-dimensional render of a three-dimensional cloth texture) as the input and predicts a two-dimensional image as the output where the output has small changes over the input but looks more photorealistic. The smooth blending models 240 can be configured to blend one or more undistorted regions to provide a more photorealistic image. The smooth blending models 240 can be used as a blender-based tool to be a constructor for choosing options or moving sliders, accessible through graphical interface or python API, for example.

In FIG. 3, during operation 304, the user can use physical production from beginning to end. In examples, physical production can take images of the apparel on a mannequin or human, and the system replaces the mannequin or human in the images with digital models. At operation 308, the user uses the mannequin. The mannequin can be a physical mannequin within the user's possession or a virtual mannequin created, designed, or generated using special outside software. At operation 310, the user uses a human model. In this example, the user can use a physical, human model. At operation 312, a user dresses the mannequin or human in one or more apparel items. At operation 322, a user sets the stage for the mannequin or human. This can include, for example, lighting, effects, camera angles, model poses, background, etc. At operation 318, the user takes photos at desired angles with desired lighting and poses with the mannequin or human model. At operation 320, the user uploads photos to systems 320. At operation 324, these photos include the images of the mannequin or human model, and the system swaps the mannequin or human with digital models. This process of swapping the human or mannequin model with a digital model can comprise using one or more of the skin machine-learning models 210, upper-body machine-learning models 220, fabric simulation machine-learning models 230, and/or smooth blending models 240.

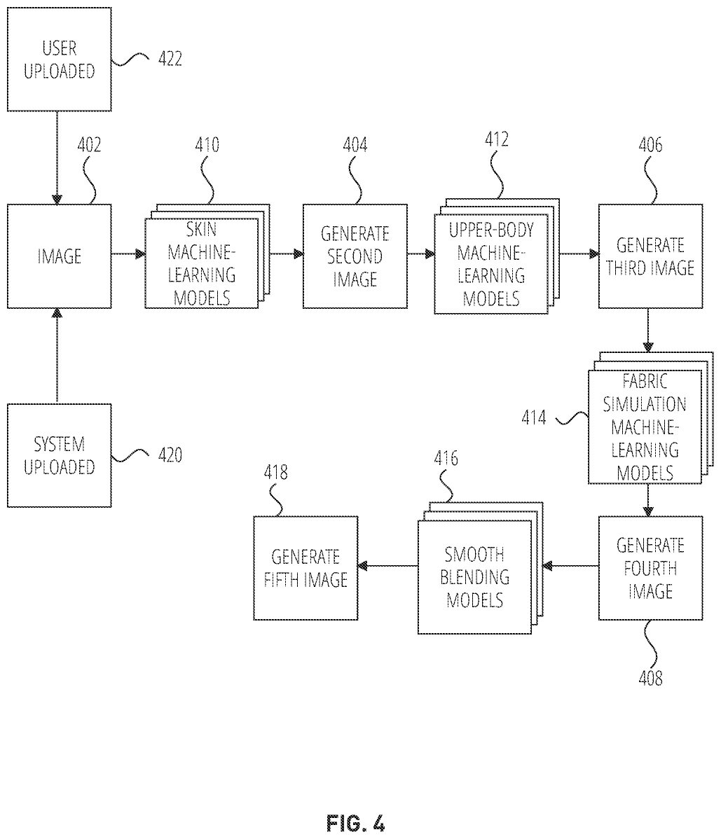

FIG. 4 provides a block diagram illustrating data flow within an example virtual production model during operation, according to various embodiments of the present disclosure. As shown, the virtual production 122 model comprises skin machine-learning models 410, upper-body machine-learning models 412, fabric simulation machine-learning models 414, and smooth blending models 416. These models are also described in the virtual production models 200 of FIG. 2.

The machine-learning models can work on three-dimensional human models that were either created in other three-dimensional software tools but were downloaded and uploaded as an input into the system, or were system generated and uploaded. Some embodiments described herein also support or provide for annotation of an input being that of a set of three-dimensional model files for apparel items. These apparel items can have been designed and generated in special software.

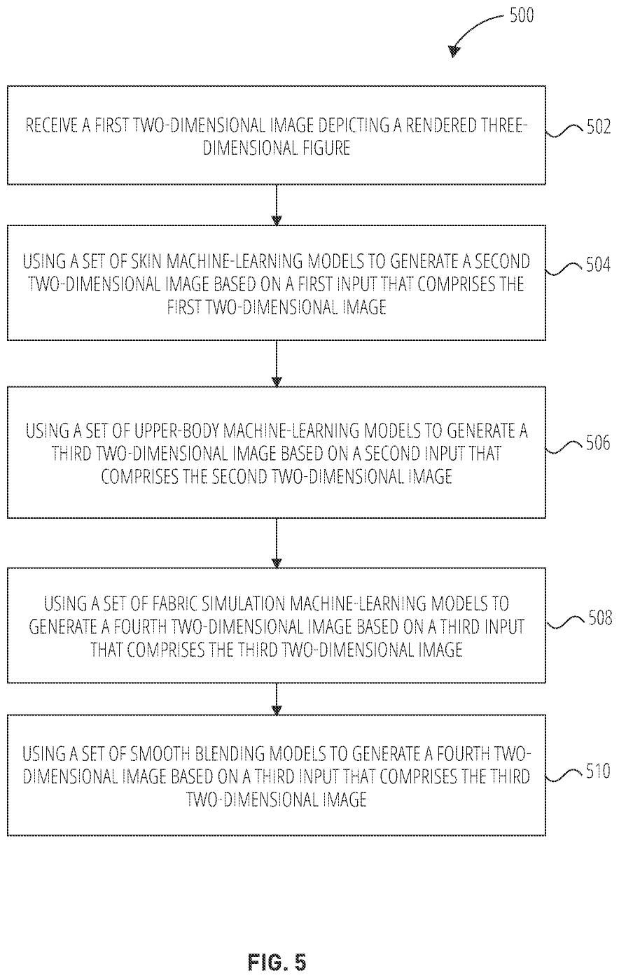

FIG. 4, however, depicts a user uploaded image 422 or system uploaded image 420 being received and processed by the different machine-learning models. For some embodiments, the image 402 can first be processed by one or more of the skin machine-learning models 410 that generate a second two-dimensional image based on a first input that comprises the first two-dimensional image. This model is described in FIG. 2 (210) and FIG. 5 (504). The set of skin machine-learning models 410 can up-sample the skin of the rendered three-dimensional figure within the first two-dimensional image. The up sampling of the skin can generate photorealistic skin in the second two-dimensional image. The set of skin machine-learning models 410 can also comprise a skin image distortion process, which includes segmenting a portion of skin of the rendered three-dimensional figure of the first two-dimensional image. The distortion process can also include selecting one or more regions within the segmented portion and selecting a size of a blur kernel. The size can be between 0 and 253 for each of the one or more regions. The one or more regions can represent a different part of a body of the rendered three-dimensional figure of the first two-dimensional image including the head, face, neck, arms, hands, legs, and hair. The distortion process can also include applying a partial convolution layer with a Gaussian kernel to each of the one or more regions with a corresponding size of the blur kernel.

At operation 404, a second image can be generated and 412 applies upper-body machine-learning models 412. One or more of the upper-body machine-learning models 412 as described in FIG. 2 (220) and FIG. 5 (506) can be configured to up-sample an upper portion of the rendered three-dimensional figure in the second two-dimensional image to generate a photorealistic upper portion in the third two-dimensional image. One or more of the upper-body machine-learning models 412 can generate a third two-dimensional image based on a second input that comprises the second two-dimensional image. In examples, one or more of the upper-body machine-learning models 412 focus on portions of the upper body including human upper body parts above the waist such as the hands, arms, forearms, shoulders, chest, back, stomach, neck, head, etc.

At operation 406, a third image can be generated. At operation 414, one or more of the fabric simulation machine-learning models 414 can be applied. One or more of the fabric simulation machine-learning models 230 are described in FIG. 2 (230) and FIG. 5 (508). One or more of the fabric simulation machine-learning models 414 generate a fourth two-dimensional image based on a third input that comprises the third two-dimensional image. One or more of the fabric simulation machine-learning models 414 can be configured to up-sample the apparel item to generate a photorealistic apparel item in the fourth two-dimensional image. In some examples, one or more of the fabric simulation machine-learning models 414 can comprise a fabric image distortion process that can comprise segmenting a portion of the apparel item in the third two-dimensional image. The distortion process can also include selecting one or more regions within the segmented portion and selecting a size of a blur kernel. In some examples, the blur kernel can be between 0 and 253 of the one or more regions and the one or more regions can represent a different fabric texture. The distortion process can also include applying a partial convolution layer with a Gaussian kernel to each of the one or more regions with a corresponding size of the blur kernel. The fabric or select apparel item can be three-dimensional and, in some examples, the fabric or select apparel item can comprise writing, logos, and/or drawings.

At operation 408, a fourth image can be generated. At operation 416, smooth blending models can be applied. The smooth blending models can be used as a blender-based tool to be a constructor for choosing options or moving sliders, accessible through graphical interface or python API, for example. The smooth blending models can be configured to blend one or more undistorted regions to provide a more photorealistic image. The smooth blending models 416 are also described in FIG. 2 and generate a fifth two-dimensional image based on a fourth input that comprises the fourth two-dimensional image. The set of smooth blending models 416 can be configured to blend one or more undistorted regions of the fourth two-dimensional image with one or more distorted regions of the third two-dimensional image. The one or more distorted regions of the third two-dimensional image can be generated by at least one of the set of skin machine-learning models or the set of upper-body machine-learning models. At operation 418, a fifth image can be generated.

FIG. 5 is a flowchart illustrating an example method 500 for virtual production, according to various embodiments of the present disclosure. It will be understood that example methods described herein can be performed by a machine in accordance with some embodiments. For example, the methods 500 can be performed by virtual production 122 as described with respect to FIG. 1, the virtual production models 200 described with respect to FIG. 2, the virtual production system described with respect to FIG. 3, or individual components thereof. An operation of various methods described herein can be performed by one or more hardware processors (e.g., central processing units or graphics processing units) of a computing device (e.g., a desktop, server, laptop, mobile phone, tablet, etc.), which can be part of a computing system based on a cloud architecture.

Example methods described herein can also be implemented in the form of executable instructions stored on a machine-readable medium or in the form of electronic circuitry. For instance, the operations of method 500 can be represented by executable instructions that, when executed by a processor of a computing device, cause the computing device to perform the method 500. Depending on the embodiment, an operation of an example method described herein can be repeated in different ways or involve intervening operations not shown. Though the operations of example methods can be depicted and described in a certain order, the order in which the operations are performed can vary among embodiments, including performing certain operations in parallel.

At operation 502, method 500 can receive a first two-dimensional image depicting a rendered three-dimensional figure, the rendered three-dimensional figure being in a pose and dressed in a select apparel item. In some examples, the select apparel items can be three-dimensional. In some examples, the select apparel items can comprise writing, logos, and/or drawings. In examples, the three-dimensional figure can be in a T pose. The figure can be that of a human being, character, animal, etc., and can be that of a male or female.

At operation 504, method 500 can use a set of skin machine-learning models as described in FIG. 2 to generate a second two-dimensional image based on a first input that comprises the first two-dimensional image. The set of skin machine-learning models can be configured to up-sample skin of the rendered three-dimensional figure in the first two-dimensional image to generate photorealistic skin in the second two-dimensional image. The set of skin machine-learning models can comprise a skin image distortion process. The skin image distortion process can comprise segmenting a portion of skin of the rendered three-dimensional figure of the first two-dimensional image. The distortion process can also include selecting one or more regions within the segmented portion and selecting a size of a blur kernel between 0 and 253 for each of the one or more regions. The one or more regions can represent a different part of a body of the rendered three-dimensional figure of the first two-dimensional image. In examples, the different parts of the body comprise at least one of a head, a face, a neck, an arm, a hand, a leg, hair, etc. The distortion process can also include applying a partial convolution layer with a Gaussian kernel to each of the one or more regions with a corresponding size of the blur kernel.

At operation 506, method 500 can use a set of upper-body machine-learning models as described in FIG. 2 to generate a third two-dimensional image based on a second input that comprises the second two-dimensional image. The set of upper-body machine-learning models can be configured to up-sample an upper portion of the rendered three-dimensional figure in the second two-dimensional image to generate a photorealistic upper portion in the third two-dimensional image. In examples, one or more of the upper-body machine-learning models focus on portions of the upper body. Some examples include human upper body parts above the waist including the hands, arms, forearms, shoulders, chest, back, stomach, neck, bead, hair, face, etc.

At operation 508, method 500 can use a set of fabric simulation machine-learning models as described in FIG. 2 to generate a fourth two-dimensional image based on a third input that comprises the third two-dimensional image. The set of fabric simulation machine-learning models can be configured to up-sample the apparel item to generate a photorealistic apparel item in the fourth two-dimensional image. In some examples, the set of fabric simulation machine-learning models can comprise a fabric image distortion process. The fabric image distortion process can comprise segmenting a portion of the apparel item in the third two-dimensional image. The distortion process can also include selecting one or more regions within the segmented portion and selecting a size of a blur kernel between 0 and 253 of the one or more regions. The one or more regions can represent a different fabric texture. The distortion process can also include applying a partial convolution layer with a Gaussian kernel to each of the one or more regions with a corresponding size of the blur kernel. The fabric or select apparel item can be three-dimensional. In some examples, the fabric or select apparel items can comprise writing, logos, and/or drawings.

At operation 510, method 500 can use a set of smooth blending models as described in FIG. 2 to generate a fifth two-dimensional image based on a fourth input that comprises the fourth two-dimensional image. The set of smooth blending models can be configured to blend one or more undistorted regions of the fourth two-dimensional image with one or more distorted regions of the fourth two-dimensional image. The one or more distorted regions of the third two-dimensional image can be generated by at least one of the set of skin machine-learning models or the set of upper-body machine-learning models.

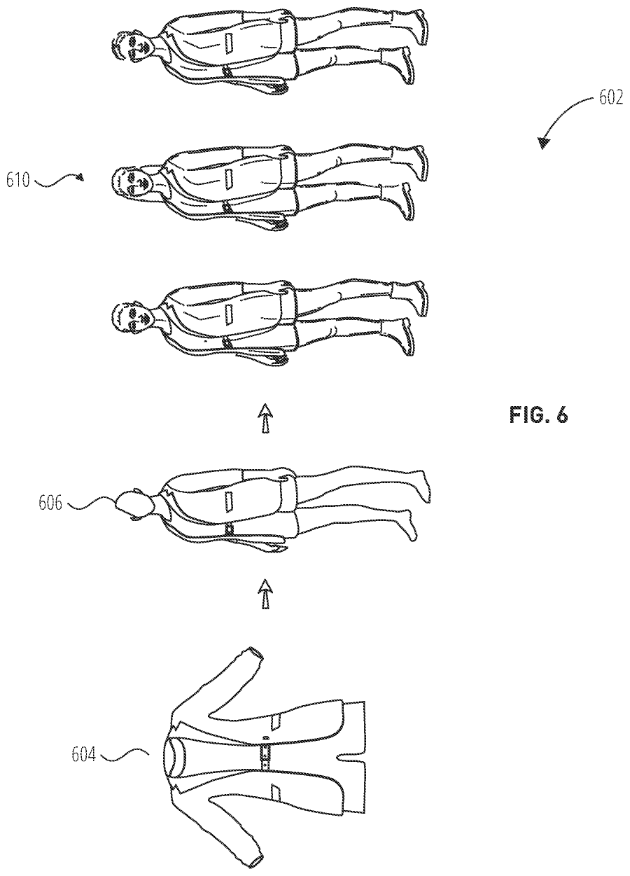

FIG. 6 provides a flowchart 602 illustrating an example method for virtual production, according to various embodiments of the present disclosure. Outside asset/apparel 604 is an example visual of the method depicted in FIG. 5 (502). The outside asset/apparel 604 provides an example apparel item, in this case a short pant suit. In examples, the outside asset/apparel 604 can be three-dimensional. The outside asset/apparel 604 can also comprise writing, logos, and/or drawings. As shown in FIG. 6, this outside asset/apparel 604 is uploaded as an input without a human or mannequin model, similar to operation 306 of FIG. 3. The outside asset/apparel 604 can have been designed and generated in special software outside of the model and have now been uploaded as the input to the model.

Upon receiving the outside asset/apparel 604, the system can put the outside asset/apparel 604 on a mannequin as shown in 606. The asset/apparel on virtual mannequin 606 is shown in the middle image using a basic and standard mannequin. This basic mannequin has no skin pigmentation or humanly realistic features. The mannequin does not include eyes, mouth, hair or eye color, fingers, nor any other human-like features. In examples, the virtual mannequin can be designed using the system or can be uploaded using an outside or self-designed model or mannequin. Then, the system swaps the mannequin with digital models, as shown in the final image. As depicted, the mannequins go from basic standard mannequins to more photorealistic and human-like mannequins (610), which can include eyes, ears, noses, hair, fingers, and other human-like photorealistic parts of the body. The human-like mannequins 610 can also provide examples of different genders, hair colors, eye colors, skin colors, etc. though the differences in color are not shown in the figures.

The process of going from asset/apparel on the virtual mannequin 606 to the photorealistic and human-like mannequins 610 can occur after applying the virtual production models 200 shown in FIG. 2. This process can include using a set of skin machine-learning models 210, a set of upper-body machine-learning models 220, a set of fabric simulation machine-learning models 230, and/or a set of smooth blending models 240. One or more of the skin machine-learning models 210 can take images of the skin (e.g., two-dimensional render of a three-dimensional skin texture) as the input and predict a two-dimensional image as the output. The output can include small changes over the input but can provide a more photorealistic look. One or more of the upper-body machine-learning models 220 can be applied to the two-dimensional rendered images to make parts of the upper body, including but not limited to hands, legs, face, hair, etc. look photorealistic.

In some examples, one or more of the fabric simulation machine-learning models 230 can be used for cloth simulation and can be configured to up-sample the apparel item to generate a photorealistic apparel item. One or more of the fabric simulation machine-learning models 230 take images of the cloth (e.g., two-dimensional render of a three-dimensional cloth texture) as the input and predict a two-dimensional image as the output where the output has small changes over the input but looks more photorealistic. The smooth blending models 240 can be used as a blender-based tool to be a constructor for choosing options or moving sliders, accessible through graphical interface or python API, for example. The smooth blending models 240 can be configured to blend one or more undistorted regions to provide a more photorealistic image.

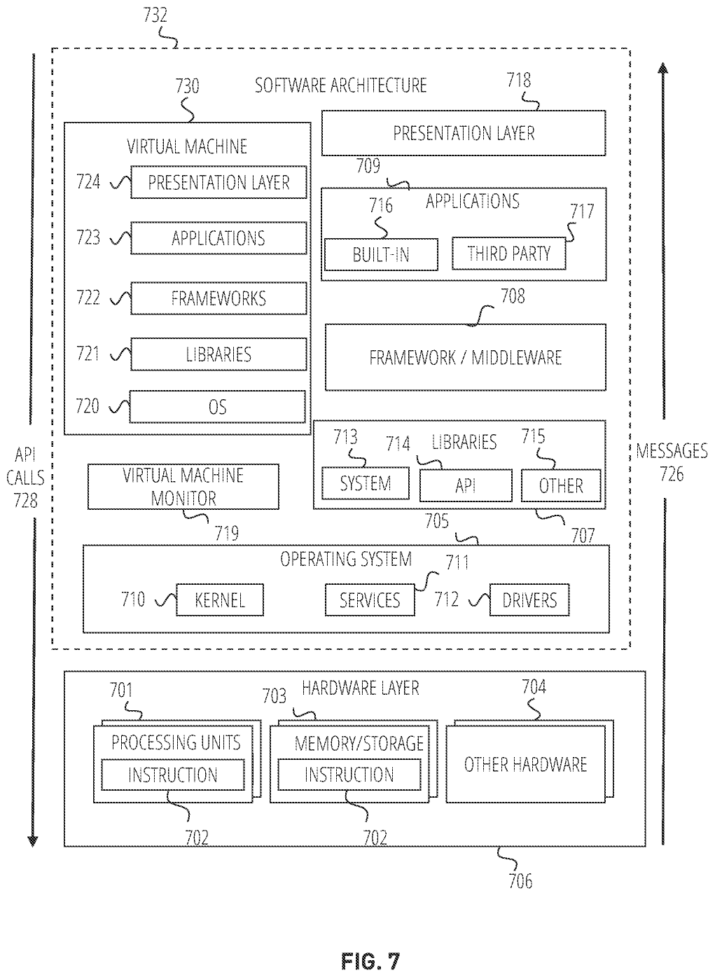

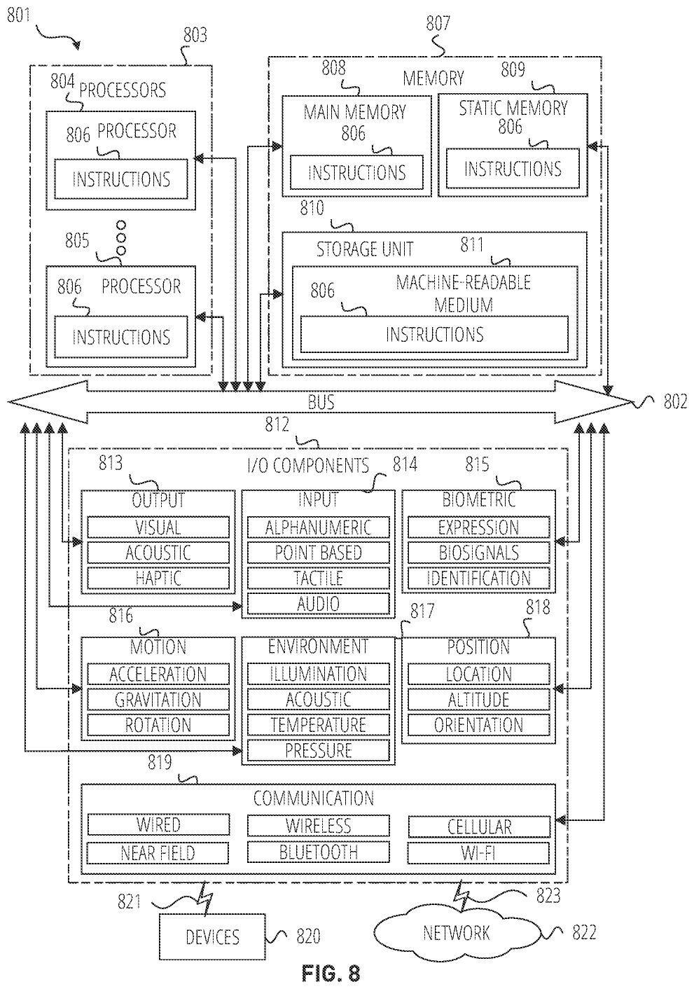

Various embodiments described herein can be implemented by way of the example software architecture 732 illustrated by and described with respect to FIG. 7 or by way of the example machine illustrated by and described with respect to FIG. 8.

FIG. 7 is a block diagram illustrating a representative software architecture 732, which can be used in conjunction with various hardware architectures herein described, according to various embodiments of the present disclosure. FIG. 7 is merely a non-limiting example of a software architecture 732, and it will be appreciated that many other architectures can be implemented to facilitate the functionality described herein. The software architecture 732 can be executed on hardware such as a machine 801 of FIG. 8 that includes, among other things, processors 803, memory 807, and input/output (I/O) i/o components 812. A representative hardware layer 706 is illustrated and can represent, for example, the machine 801 of FIG. 8. The representative hardware layer 706 comprises one or more processing units 701 having associated executable instructions 702. The executable instructions 702 represent the executable instructions of the software architecture 732. The hardware layer 706 also includes memory or storage modules 703, which also have the executable instructions 702. The hardware layer 706 can also comprise other hardware 704, which represents any other hardware of the hardware layer 706, such as the other hardware illustrated as part of the machine 801.

In the example architecture of FIG. 7, the software architecture 732 can be conceptualized as a stack of layers, where each layer provides particular functionality. For example, the software architecture 732 can include layers such as an operating system 720, libraries 707, framework/middleware 708, applications 709, and a presentation layer 718. Operationally, the applications 709 or other components within the layers can invoke API calls 728 through the software stack and receive a response, returned values, and so forth (illustrated as messages 726) in response to the API calls 728. The layers illustrated are representative in nature, and not all software architectures have all layers. For example, some mobile or special-purpose operating systems cannot provide a framework/middleware 708, while others can provide such a layer. Other software architectures can include additional or different layers.

The operating system 720 can manage hardware resources and provide common services. The operating system 705 can include, for example, a kernel 710, services 711, and drivers 712. The kernel 710 can act as an abstraction layer between the hardware and the other software layers. For example, the kernel 710 can be responsible for memory management, processor management (e.g., scheduling), component management, networking, security settings, and so on. The services 711 can provide other common services for the other software layers. The drivers 712 can be responsible for controlling or interfacing with the underlying hardware. For instance, the drivers 712 can include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 707 can provide a common infrastructure that can be utilized by the applications 709 and/or other components and/or layers. The libraries 707 typically provide functionality that allows other software modules to perform tasks in an easier fashion than by interfacing directly with the underlying operating system 720 functionality (e.g., kernel 710, services 711, or drivers 712). The libraries 707 can include system libraries 713 (e.g., C standard library) that can provide functions such as memory allocation functions, string manipulation functions, mathematical functions, and the like. In addition, the libraries 707 can include API libraries 714 such as media libraries (e.g., libraries to support presentation and manipulation of various media formats such as MPEG4, H.264, MP3, AAC, AMR, JPG, and PNG), graphics libraries (e.g., an OpenGL framework that can be used to render two-dimensional and three-dimensional graphic content on a display), database libraries (e.g., SQLite that can provide various relational database functions), web libraries (e.g., WebKit that can provide web browsing functionality), and the like. The libraries 707 can also include a wide variety of other libraries 715 to provide many other APIs to the applications 709 and other software components/modules.

The frameworks 722 (also sometimes referred to as middleware) can provide a higher-level common infrastructure that can be utilized by the applications 709 or other software components/modules. For example, the frameworks 722 can provide various graphical user interface functions, high-level resource management, high-level location services, and so forth. The frameworks 722 can provide a broad spectrum of other APIs that can be utilized by the applications 709 and/or other software components/modules, some of which can be specific to a particular operating system or platform.

The applications 709 include built-in applications 716 and/or third party applications 717. Examples of representative built-in applications 716 can include, but are not limited to, a home application, a contacts application, a browser application, a book reader application, a location application, a media application, a messaging application, or a game application.

The third party applications 717 can include any of the built-in applications 716, as well as a broad assortment of other applications. In a specific example, the third party applications 717 (e.g., an application developed using the Android™ or iOS™ software development kit (SDK) by an entity other than the vendor of the particular platform) can be mobile software running on a mobile operating system such as iOS™, Android™, or other mobile operating systems. In this example, the third party applications 717 can invoke the API calls 728 provided by the mobile operating system such as the operating system 720 to facilitate functionality described herein.

The applications 709 can utilize built-in operating system functions (e.g., kernel 710, services 711, or drivers 712), libraries (e.g., system libraries 713, API libraries 714, and other libraries 715), or framework/middleware 708 to create user interfaces to interact with users of the system. Alternatively, or additionally, in some systems, interactions with a user can occur through a presentation layer, such as the presentation layer 718. In these systems, the application/module “logic” can be separated from the aspects of the application/module that interact with the user.

Some software architectures utilize virtual machines. In the example of FIG. 7, this is illustrated by a virtual machine 730. The virtual machine 730 creates a software environment where applications/modules can execute as if they were executing on a hardware machine (e.g., the machine 801 of FIG. 8). The virtual machine 730 is hosted by a host operating system (e.g., the operating system 720) and typically, although not always, has a virtual machine monitor 719, which manages the operation of the virtual machine 730 as well as the interface with the host operating system (e.g., the operating system 720). A software architecture executes within the virtual machine 730, such as an operating system 720, libraries 721, framework/middleware 708, applications 723, or a presentation layer 724. These layers of software architecture executing within the virtual machine 730 can be the same as corresponding layers previously described or can be different.

FIG. 8 provides a block diagram illustrating components of a machine able to read instructions from a machine storage medium and perform any one or more of the methodologies discussed herein according to various embodiments of the present disclosure. Specifically, FIG. 8 shows a diagrammatic representation of the machine 801 in the example form of a computer system, within which instructions 806 (e.g., software, a program, an application, an applet, an app, or other executable code) for causing the machine 801 to perform any one or more of the methodologies discussed herein can be executed. For example, the instructions 806 can cause the machine 801 to execute the method 500 described above with respect to FIG. 5. The instructions 806 transform the general, non-programmed machine 801 into a particular machine 801 programmed to carry out the described and illustrated functions in the manner described.

In alternative embodiments, the machine 801 operates as a standalone device or can be coupled (e.g., networked) to other machines. In a networked deployment, the machine 801 can operate in the capacity of a server machine or a client machine in a server-client network environment, or as a peer machine in a peer-to-peer (or distributed) network environment. The machine 801 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 806, sequentially or otherwise, that specify actions to be taken by the machine 801. Further, while only a single machine 801 is illustrated, the term “machine” shall also be taken to include a collection of machines 801 that individually or jointly execute the instructions 806 to perform any one or more of the methodologies discussed herein.

The machine 801 can include processors 803, memory 807, and I/o components 812, which can be configured to communicate with each other such as via a bus 802. In an embodiment, the processors 803 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) can include, for example, a processor 804 and a processor 805 that can execute the instructions 806. The term “processor” is intended to include multi-core processors that can comprise two or more independent processors (sometimes referred to as “cores”) that can execute instructions contemporaneously. Although FIG. 8 shows multiple processors 803, the machine 801 can include a single processor with a single core, a single processor with multiple cores (e.g., a multi-core processor), multiple processors with a single core, multiple processors with multiples cores, or any combination thereof.

The memory 807 can include a main memory 808, a static memory 809, and a storage unit 810 including machine-readable medium 811, each accessible to the processors 803 such as via the bus 802. The main memory 808, the static memory 809, and the storage unit 810 store the instructions 806 embodying any one or more of the methodologies or functions described herein. The instructions 806 can also reside, completely or partially, within the main memory 808, within the static memory 809, within the storage unit 810, within at least one of the processors 803 (e.g., within the processor's cache memory), or any suitable combination thereof, during execution thereof by the machine 801.

The I/o components 812 can include a wide variety of components to receive input, provide output, produce output, transmit information, exchange information, capture measurements, and so on. The specific I/o components 812 that are included in a particular machine will depend on the type of machine. For example, portable machines such as mobile phones will likely include a touch input device or other such input mechanisms, while a headless server machine will likely not include such a touch input device. It will be appreciated that the I/o components 812 can include many other components that are not shown in FIG. 8. The I/o components 812 are grouped according to functionality merely for simplifying the following discussion, and the grouping is in no way limiting.

In various embodiments, the I/o components 812 can include output components 813 and input components 814. The output components 813 can include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 814 can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/o components 812 can include biometric components 815, motion components 816, environmental components 817, or position components 818, among a wide array of other components. The motion components 816 can include acceleration sensor components (e.g., accelerometer), gravitation sensor components, rotation sensor components (e.g., gyroscope), and so forth. The environmental components 817 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), or other components that can provide indications, measurements, or signals corresponding to a surrounding physical environment. The position components 818 can include location sensor components (e.g., a Global Positioning System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/o components 812 can include communication components 819 operable to couple the machine 801 to a network 822 or devices 820 via a coupling 821 and a coupling 823, respectively. For example, the communication components 819 can include a network interface component or another suitable device to interface with the network 106. In further examples, the communication components 819 can include wired communication components, wireless communication components, cellular communication components, near field communication (NFC) components, Bluetooth® components (e.g., Bluetooth® Low Energy), Wi-Fi® components, and other communication components to provide communication via other modalities. The devices 820 can be another machine or any of a wide variety of peripheral devices (e.g., a peripheral device coupled via a USB).

Moreover, the communication components 819 can detect identifiers or include components operable to detect identifiers. For example, the communication components 819 can include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 819, such as location via Internet Protocol (IP) geolocation, location via Wi-Fi® signal triangulation, location via detecting an NFC beacon signal that can indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. For some embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some embodiments, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module can also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules can be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines 801 including processors 803), with these operations being accessible via a network (e.g., the Internet) and via one or more appropriate interfaces (e.g., an API). In certain embodiments, for example, a client device can relay or operate in communication with cloud computing systems, and can access circuit design information in a cloud environment.

The performance of certain of the operations can be distributed among the processors, not only residing within a single machine 801, but deployed across a number of machines 801. In some embodiments, the processors 1210 or processor-implemented modules are located in a single geographic location (e.g., within a home environment, an office environment, or a server farm). In other embodiments, the processors or processor-implemented modules are distributed across a number of geographic locations.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: a set of skin machine-learning models; a set of upper-body machine-learning models; a memory storing instructions; and one or more hardware processors communicatively coupled to the memory and configured by the instructions to perform operations comprising: receiving a first two-dimensional image depicting a rendered three-dimensional figure, the rendered three-dimensional figure being in a pose and dressed in a select apparel item; using the set of skin machine-learning models to generate a second two-dimensional image based on a first input that comprises the first two-dimensional image, the set of skin machine-learning models being configured to up-sample skin of the rendered three-dimensional figure in the first two-dimensional image to generate photorealistic skin in the second two-dimensional image; and using the set of upper-body machine-learning models to generate a third two-dimensional image based on a second input that comprises the second two-dimensional image, the set of upper-body machine-learning models being configured to up-sample an upper portion of the rendered three-dimensional figure in the second two-dimensional image to generate a photorealistic upper portion in the third two-dimensional image.

In Example 2, the subject matter of Example 1 includes, wherein the set of skin machine-learning models comprises a skin image distortion process, the skin image distortion process comprising: segmenting a portion of skin of the rendered three-dimensional figure of the first two-dimensional image; selecting one or more regions within the segmented portion and selecting a size of a blur kernel between 2 is missing parent: 0 and 2 is missing parent: 253 for each of the one or more regions, the one or more regions representing a different part of a body of the rendered three-dimensional figure of the first two-dimensional image; and applying a partial convolution layer with a Gaussian kernel to each of the one or more regions with a corresponding size of the blur kernel.

In Example 3, the subject matter of Example 2 includes, wherein the different part of the body comprises at least one of a head, a face, a neck, an arm, a hand, a leg, or hair.

In Example 4, the subject matter of Examples 1-3 includes, a set of fabric simulation machine-learning models, the operations comprising: using the set of fabric simulation machine-learning models to generate a fourth two-dimensional image based on a third input that comprises the third two-dimensional image, the set of fabric simulation machine-learning models being configured to up-sample the select apparel item to generate a photorealistic apparel item in the fourth two-dimensional image.

In Example 5, the subject matter of Example 4 includes, wherein the set of fabric simulation machine-learning models comprises a fabric image distortion process, the fabric image distortion process comprising: segmenting a portion of the select apparel item in the third two-dimensional image; selecting one or more regions within the segmented portion and selecting a size of a blur kernel between 5 is missing parent: 0 and 5 is missing parent: 253 of the one or more regions, the one or more regions representing a different fabric texture; and applying a partial convolution layer with a Gaussian kernel to each of the one or more regions with a corresponding size of the blur kernel.

In Example 6, the subject matter of Examples 4-5 includes, a set of smooth blending models, the operations comprising: using the set of smooth blending models to generate a fifth two-dimensional image based on a fourth input that comprises the fourth two-dimensional image, the set of smooth blending models being configured to blend one or more undistorted regions of the fourth two-dimensional image with one or more distorted regions of the third two-dimensional image, the one or more distorted regions of the third two-dimensional image being generated by at least one of the set of skin machine-learning models or the set of upper-body machine-learning models.

In Example 7, the subject matter of Examples 1-6 includes, wherein the select apparel item is three-dimensional.

In Example 8, the subject matter of Examples 1-7 includes, wherein the select apparel item comprises writing, logos, and drawings.

In Example 9, the subject matter of Examples 1-8 includes, wherein the rendered three-dimensional figure is a human figure.

Example 10 is at least one machine-readable medium including instructions that, when executed by a hardware processor of a device, cause the device to perform operations to implement of any of Examples 1-9.

Example 11 is a method to implement of any of Examples 1-9.

### Executable Instructions and Machine Storage Medium

The various memories (i.e., 807, 808, 809, and/or the memory of the processor(s) 803) and/or the storage unit 810 can store one or more sets of instructions 806 and data structures (e.g., software) embodying or utilized by any one or more of the methodologies or functions described herein. These instructions (e.g., the instructions 806), when executed by the processor(s) 803, cause various operations to implement the disclosed embodiments.

As used herein, the terms “machine-storage medium,” “device-storage medium,” and “computer-storage medium” mean the same thing and can be used interchangeably. The terms refer to a single or multiple storage devices and/or media (e.g., a centralized or distributed database, and/or associated caches and servers) that store executable instructions 806 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various embodiments, one or more portions of the network 822 can be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 822 or a portion of the network 822 can include a wireless or cellular network, and the coupling 823 can be a Code Division Multiple Access (CDMA) connection, a Global System for Mobile communications (GSM) connection, or another type of cellular or wireless coupling. In this example, the coupling 823 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions can be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions can be transmitted or received using a transmission medium via the coupling (e.g., a peer-to-peer coupling) to the devices 820. The terms “transmission medium” and “signal medium” mean the same thing and can be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and can be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances can implement resources, components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components.

As used herein, the term “or” can be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases can be absent. Additionally, boundaries between various resources, operations, modules, engines, and data stores are somewhat arbitrary, and particular operations are illustrated in a context of specific illustrative configurations. Other allocations of functionality are envisioned and can fall within a scope of various embodiments of the present disclosure. The specification and drawings are, accordingly, to be regarded in an illustrative rather than a restrictive sense.

It will be understood that changes and modifications can be made to the disclosed embodiments without departing from the scope of the present disclosure. These and other changes or modifications are intended to be included within the scope of the present disclosure.

What is claimed is:

1. A system comprising:
a set of skin machine-learning models;
a set of upper-body machine-learning models;
a memory storing instructions; and
one or more hardware processors communicatively coupled to the memory and configured by the instructions to perform operations comprising:
receiving a first two-dimensional image depicting a rendered three-dimensional figure, the rendered three-dimensional figure being in a pose and dressed in a select apparel item;
using the set of skin machine-learning models to generate a second two-dimensional image based on a first input that comprises the first two-dimensional image, the set of skin machine-learning models being configured to up-sample skin of the rendered three-dimensional figure in the first two-dimensional image to generate photorealistic skin in the second two-dimensional image; and
using the set of upper-body machine-learning models to generate a third two-dimensional image based on a second input that comprises the second two-dimensional image, the set of upper-body machine-learning models being configured to up-sample an upper portion of the rendered three-dimensional figure in the second two-dimensional image to generate a photorealistic upper portion in the third two-dimensional image.

2. The system of claim 1, wherein the set of skin machine-learning models comprises a skin image distortion process, the skin image distortion process comprising:
segmenting a portion of skin of the rendered three-dimensional figure of the first two-dimensional image;
selecting one or more regions within the segmented portion and selecting a size of a blur kernel between 0 and 253 for each of the one or more regions, the one or more regions representing a different part of a body of the rendered three-dimensional figure of the first two-dimensional image; and
applying a partial convolution layer with a Gaussian kernel to each of the one or more regions with a corresponding size of the blur kernel.

3. The system of claim 2, wherein the different part of the body comprises at least one of a head, a face, a neck, an arm, a hand, a leg, or hair.

4. The system of claim 1, comprising a set of fabric simulation machine-learning models, the operations comprising:
using the set of fabric simulation machine-learning models to generate a fourth two-dimensional image based on a third input that comprises the third two-dimensional image, the set of fabric simulation machine-learning models being configured to up-sample the select apparel item to generate a photorealistic apparel item in the fourth two-dimensional image.

5. The system of claim 4, wherein the set of fabric simulation machine-learning models comprises a fabric image distortion process, the fabric image distortion process comprising:
segmenting a portion of the select apparel item in the third two-dimensional image;
selecting one or more regions within the segmented portion and selecting a size of a blur kernel between 0 and 253 of the one or more regions, the one or more regions representing a different fabric texture; and
applying a partial convolution layer with a Gaussian kernel to each of the one or more regions with a corresponding size of the blur kernel.

6. The system of claim 4, comprises a set of smooth blending models, the operations comprising:
using the set of smooth blending models to generate a fifth two-dimensional image based on a fourth input that comprises the fourth two-dimensional image, the set of smooth blending models being configured to blend one or more undistorted regions of the fourth two-dimensional image with one or more distorted regions of the third two-dimensional image, the one or more distorted regions of the third two-dimensional image being generated by at least one of the set of skin machine-learning models or the set of upper-body machine-learning models.

7. The system of claim 1, wherein the select apparel item is three-dimensional.

8. The system of claim 1, wherein the select apparel item comprises writing, logos, and drawings.

9. The system of claim 1, wherein the rendered three-dimensional figure is a human figure.

10. A non-transitory computer-readable medium comprising instructions that, when executed by a hardware processor of a device, cause the device to perform operations comprising:
receiving a first two-dimensional image depicting a rendered three-dimensional figure, the rendered three-dimensional figure being in a pose and dressed in a select apparel item;
using a set of skin machine-learning models to generate a second two-dimensional image based on a first input that comprises the first two-dimensional image, the set of skin machine-learning models being configured to up-sample skin of the rendered three-dimensional figure in the first two-dimensional image to generate photorealistic skin in the second two-dimensional image; and
using a set of upper-body machine-learning models to generate a third two-dimensional image based on a second input that comprises the second two-dimensional image, the set of upper-body machine-learning models being configured to up-sample an upper portion of the rendered three-dimensional figure in the second two-dimensional image to generate a photorealistic upper portion in the third two-dimensional image.

11. The non-transitory computer-readable medium of claim 10, wherein the set of skin machine-learning models comprises a skin image distortion process, the skin image distortion process comprising:
segmenting a portion of skin of the rendered three-dimensional figure of the first two-dimensional image;
selecting one or more regions within the segmented portion and selecting a size of a blur kernel between 0 and 253 for each of the one or more regions, the one or more regions representing a different part of a body of the rendered three-dimensional figure of the first two-dimensional image; and
applying a partial convolution layer with a Gaussian kernel to each of the one or more regions with a corresponding size of the blur kernel.

12. The non-transitory computer-readable medium of claim 11, wherein the different part of the body comprises at least one of a head, a face, a neck, an arm, a hand, a leg, or hair.

13. The non-transitory computer-readable medium of claim 10, wherein the operations comprise:
using a set of fabric simulation machine-learning models to generate a fourth two-dimensional image based on a third input that comprises the third two-dimensional image, the set of fabric simulation machine-learning models being configured to up-sample the select apparel item to generate a photorealistic apparel item in the fourth two-dimensional image.

14. The non-transitory computer-readable medium of claim 13, wherein the set of fabric simulation machine-learning models comprises a fabric image distortion process, the fabric image distortion process comprising:
segmenting a portion of the select apparel item in the third two-dimensional image;
selecting one or more regions within the segmented portion and selecting a size of a blur kernel between 0 and 253 of the one or more regions, the one or more regions representing a different fabric texture; and
applying a partial convolution layer with a Gaussian kernel to each of the one or more regions with a corresponding size of the blur kernel.

15. The non-transitory computer-readable medium of claim 13, wherein the operations comprise:
using a set of smooth blending models to generate a fifth two-dimensional image based on a fourth input that comprises the fourth two-dimensional image, the set of smooth blending models being configured to blend one or more undistorted regions of the fourth two-dimensional image with one or more distorted regions of the third two-dimensional image, the one or more distorted regions of the third two-dimensional image being generated by at least one of the set of skin machine-learning models or the set of upper-body machine-learning models.

16. The non-transitory computer-readable medium of claim 10, wherein the select apparel item is three-dimensional and comprises writing, logos, and drawings.

17. The non-transitory computer-readable medium of claim 10, wherein the rendered three-dimensional figure is a human figure.

18. A method comprising:
receiving, by one or more hardware processors, a first two-dimensional image depicting a rendered three-dimensional figure, the rendered three-dimensional figure being in a pose and dressed in a select apparel item;
using, by the one or more hardware processors, a set of skin machine-learning models to generate a second two-dimensional image based on a first input that comprises the first two-dimensional image, the set of skin machine-learning models being configured to up-sample skin of the rendered three-dimensional figure in the first two-dimensional image to generate photorealistic skin in the second two-dimensional image; and
using, by the one or more hardware processors, a set of upper-body machine-learning models to generate a third two-dimensional image based on a second input that comprises the second two-dimensional image, the set of upper-body machine-learning models being configured to up-sample an upper portion of the rendered three-dimensional figure in the second two-dimensional image to generate a photorealistic upper portion in the third two-dimensional image.

19. The method of claim 18, comprising:
using, by the one or more hardware processors, a set of fabric simulation machine-learning models to generate a fourth two-dimensional image based on a third input that comprises the third two-dimensional image, the set of fabric simulation machine-learning models being configured to up-sample the select apparel item to generate a photorealistic apparel item in the fourth two-dimensional image.

20. The method of claim 19, comprising:
using, by the one or more hardware processors, a set of smooth blending models to generate a fifth two-dimensional image based on a fourth input that comprises the fourth two-dimensional image, the set of smooth blending models being configured to blend one or more undistorted regions of the fourth two-dimensional image with one or more distorted regions of the third two-dimensional image, the one or more distorted regions of the third two-dimensional image being generated by at least one of the set of skin machine-learning models or the set of upper-body machine-learning models.
